(19) United States
(12) Patent Application Publication
(10) Pub. No.: US 2007/0247782 A1
(43) Pub. Date: Oct. 25, 2007

(54) DIELECTRIC DEVICE

(75) Inventors: Tsutomu Nanataki, Toyoake-City (JP); Nobuyuki Kobayashi, Nagoya-City (JP)

Correspondence Address: BURR & BROWN, PO BOX 7068, SYRACUSE, NY, 13261-7068, US

(73) Assignee: NGK Insulators, Ltd., Nagoya-City (JP)

(21) Appl. No.: 11/563,843

(22) Filed: Nov. 28, 2006

(30) Foreign Application Priority Data
Apr. 19, 2006 (JP) 2006-115951

(51) Int. Cl. H04R 17/00

(52) U.S. Cl. 361/303; 257/306; 361/322; 29/25.35

(57) ABSTRACT

The invention suppresses the occurrence of cracks in a dielectric layer, and improve yield during manufacture of a dielectric device. A dielectric device includes a substrate, a base electrode and a dielectric layer. The base electrode is fixed on the substrate. The base electrode is formed such that a surface of a base electrode edge part has an inclined part. The dielectric layer is fixed on a substrate surface so as to cover the base electrode. The dielectric layer is formed by annealing a deposited layer obtained by spraying a powdered dielectric on the substrate surface. Therefore, a triple point adjacent part, which is a part of the dielectric layer opposite the base electrode edge part, is formed so as to have a dense structure in the same way as other parts.

### BACKGROUND OF THE INVENTION

1. Field of the Invention

The present invention relates to a dielectric device, and to a method of manufacturing same.

2. Description of the Related Art

Various types of dielectric device are known. Most of these dielectric devices include a substrate, a lower electrode, a dielectric layer and an upper electrode. The lower electrode is formed on the surface of the substrate. The dielectric layer is provided on the surface of the substrate so as to cover the lower electrode. The dielectric layer is formed by such as screen printing, the green sheet method, aerosol deposition or powder jet deposition on the substrate on which the lower electrode layer is formed. The upper electrode is then formed on this dielectric layer.

Here, in the screen printing method, the dielectric layer is obtained by forming a film of a slurry of a ceramic powder dispersed in a solvent containing an organic binder on the substrate by screen printing, and sintering this film at a high temperature of 900° C. or more. In the green sheet method, the dielectric layer is obtained by forming a film of the aforesaid slurry to a predetermined thickness and drying to obtain a green sheet, performing predetermined mechanical operations such as cutting or hole punching, and sintering at a high temperature in the same way as above. In the aerosol deposition method, the dielectric layer is obtained by dispersing a powder in a gas using vibration or the like so as to form smoke or aerosol, transporting this aerosol to a deposition chamber at normal temperature and a predetermined reduced pressure, and spraying it on a predetermined substrate via a nozzle. In the powder jet deposition method, the dielectric layer is obtained by transporting a powder by high pressure gas, and high-speed spraying it on a substrate in the atmosphere via a nozzle.

Typical examples of this dielectric device are a piezoelectric actuator and an electron emitter.

A piezoelectric actuator is configured to deform the dielectric layer by applying a predetermined voltage between the lower electrode layer and the upper electrode layer and applying a predetermined electric field to the dielectric layer. For example, in the unimorph type of piezoelectric actuator disclosed in JP-A 2002-217465, the substrate is given a curvature deformation by extension/contraction based on a piezoelectric transversal effect of the dielectric layer fixed to the substrate.

An electron emitter can be used as an electron beam source in various types of device using electron beams (e.g., field emission displays (FED), electron beam irradiation devices, light sources, electronic component manufacturing devices and electronic circuit components).

The electron emitter device includes an emitter part disposed in a reduced pressure atmosphere at a predetermined degree of vacuum. This emitter part includes the aforesaid dielectric layer, electrons being emitted into the reduced pressure atmosphere by applying a predetermined driving electric field between the lower electrode and upper electrode. Examples of this electron emitter known in the art are disclosed in, for example, JP-A 2005-183361, and US Patent 2006/0012279.

In some dielectric devices, the dielectric layer is formed by the aerosol deposition method. The dielectric layer in this type of dielectric device has the following features: (1) the crystal structure of the starting material powder is maintained, (2) a fine deposited layer with very few voids is formed, (3) it is easy to perform thickness control and to be thick-layered, (4) the bond between the formed dielectric layer and the substrate is strong, (5) the deposited layer is formed at ordinary temperature, so it can be formed on a glass substrate or metal substrate which has a low heat resistance.

Examples of a dielectric device using this aerosol deposition method known in the prior art are disclosed for example in US Patent 2006/0012279, JP-A 2006-049806, and JP-A2005-280349.

### SUMMARY OF THE INVENTION

In the method of manufacturing the aforesaid various types of dielectric devices, a heating process such as sintering or annealing is normally performed. In this heating process, due to the difference in the thermal expansion coefficients of the substrate, lower electrode, dielectric layer and upper electrode, cracks may appear in the dielectric layer.

For example, making a deposited layer by the aerosol deposition method is based on the following principle. Starting material particles accelerated to subsonic speed collide with the substrate. Due to the collisions, a rapid deformation takes place accompanied by crystal face slips and movement of dislocations and the crystal structure becomes finer. At this time, material displacements occur due to the formation of new surfaces and impact forces, which leads to the formation of inter-particle bonds.

As a result, when the deposited layer is formed, crystal properties in the deposited layer become disordered, i.e., lattice defects, lattice distortion and internal stresses are generated, and in this situation, satisfactory piezoelectric characteristics and polarization reversal characteristics cannot be obtained. Hence, in order to restore the crystal properties of the deposited layer and obtain predetermined characteristics, annealing is normally performed at a temperature of 500 ° C. or more. During this annealing, cracks may occur in the dielectric layer.

It might be thought that these cracks could be suppressed by selecting a material having a thermal expansion coefficient close to that of the deposited layer for the substrate and lower electrode. However, the material of the lower electrode is generally a metal material having a larger thermal expansion coefficient than that of the dielectric material. Therefore, it is difficult to suppress formation of cracks by adjusting the thermal expansion coefficient.

It is therefore an object of the invention to suppress the occurrence of cracks in the aforesaid dielectric layer, and increase the yield when the dielectric device is manufactured. It is a further object of the invention to provide a dielectric device having a dielectric layer with superior characteristics formed by the aerosol deposition method with good yield during the manufacturing process.

The dielectric device of the invention includes a predetermined substrate, base electrode and dielectric layer. The base electrode includes a conductive film on the surface of the substrate. The dielectric layer is provided so as to cover the base electrode. An outer electrode may be further provided on this dielectric layer.

The essential feature of the invention is the unique shape of the base electrode. This base electrode is formed so that the surface of its edge part is an inclined surface having an inclination angle of 90° or less. In other words, the base electrode is formed so that the angle between the substrate surface and the base electrode surface is 90° or more (preferably an obtuse angle).

Specifically, the base electrode is formed so that the angle between the portion of the substrate surface where the base electrode is not formed (portion outside the base electrode) and the surface of the edge part in the base electrode which is provided to be continuous with the portion, is 90° or more (preferably 120° or more, and more preferably 150° or more).

For example, the surface of the edge part connecting the top face of the base electrode with the portion of the substrate surface where the base electrode is not formed, is an inclined surface having a slope of 90° or less. More preferably, the surface of the edge part opposite the dielectric layer in the vicinity of the interface between the substrate and the base electrode is an inclined surface having a gradual slope (60° or less, and still more preferably 30° or less).

In other words, in the invention, the inclination angle of the surface of the edge part of the base electrode is set to be 90° or less. This inclination angle is preferably set to be 60° or less, and more preferably 30° or less.

In addition to the outer rim of the base electrode, the edge part having this shape may be formed on the inner rim of a through hole or pinhole.

The edge part of the base electrode may be formed of a material having a non-metal as its main component, and the electrode body which is the part other than the edge part may be formed of a material having a metal as its main component. In this case, the edge part may be formed of an oxide or an inorganic component. This inorganic component is glassified when the base electrode is formed by annealing the paste film formed on the substrate surface.

The dielectric device of the invention having the aforesaid construction may be formed by the following manufacturing method.

First, the base electrode is formed on the substrate surface (base electrode-forming step). In this base electrode-forming step, the base electrode is formed so that the surface of the edge part is an inclined surface having an inclination angle of 90 or less. In other words, the base electrode is formed so that the angle between the substrate surface and the base electrode surface is 90° or more.

In this base electrode-forming step, the following steps are preferably performed.

First, a film of a paste which is a mixture of a base material and an additive which is an oxide or an inorganic material glassified by heating, is formed on a substrate surface (paste film-forming step).

Next, the base electrode is formed by annealing this paste film formed in the aforesaid paste film-forming step so as to cause migration of the aforesaid additive (paste film annealing step). Due to this paste film annealing step, the electrode body including the base material and the edge part including the additive, are formed.

Following the base electrode-forming step, a deposited layer of a dielectric material is formed so as to cover the base electrode on the substrate surface (deposited layer forming step). In this deposited layer forming step, a step is preferably performed for spraying powdered dielectric on the substrate as is typically performed in the aerosol deposition method.

When this deposited layer forming step by spraying dielectric powder is performed, the dielectric powder is sprayed on the substrate and the base electrode. At this time, as described above, if the surface of the edge part of the base electrode is an inclined surface having an inclination angle of 90° or less, the collision angle of the dielectric powder on the surface of the edge part is close to the collision angle of the dielectric powder on the surface of the substrate. Due to this, density differences of the deposited layer between the part in the vicinity of the edge part of the base electrode, and other parts, do not easily occur.

The dielectric layer is then obtained by annealing the deposited layer formed by the aforesaid deposited layer forming step (deposited layer annealing step). At this time, as described above, the surface of the edge part of the base electrode is an inclined surface having an inclination angle of 90° or less, and density differences of the deposited layer become smaller. Therefore, the occurrence of cracks in the part near the edge part of the base electrode is effectively suppressed.

A step of forming an outer electrode (outer electrode forming step) on the obtained dielectric layer, may also be performed.

### BRIEF DESCRIPTION OF THE DRAWINGS

FIG. 1 is a cross-sectional view showing an enlargement of a dielectric device according to one embodiment of the invention;

FIG. 2 is a flowchart showing an outline of a method of manufacturing the dielectric device according to a first aspect of the invention;

FIG. 3 is a flowchart showing an outline of a method of manufacturing the dielectric device according to a second aspect of the invention;

FIG. 4 is a diagram showing the schematic construction of an aerosol deposition device used in a deposited layer forming step of FIG. 2 and FIG. 3;

FIG. 5 is a side cross-sectional view schematically showing the process of forming a base electrode and a dielectric layer in a manufacturing method according to this example; and

FIG. 6 is a side cross-sectional view schematically showing the process of forming a base electrode and a dielectric layer in a manufacturing method according to a comparative example.

### DESCRIPTION OF THE PREFERRED EMBODIMENTS

Hereafter, suitable aspects and embodiments of the invention will be described referring to the diagrams and tables. Regarding the materials and structures of the component elements of these aspects, since it is easier to understand one aspect from beginning to end, only one typical example will be described for convenience. Regarding modifications relating to the materials and structures of the component elements of this aspect, these will be described at the end following the construction, effect and advantages of the aspect.

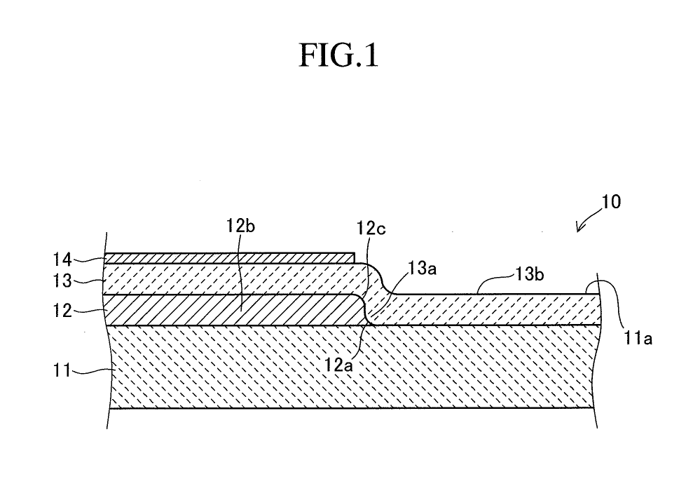

Schematic construction of dielectric device FIG. 1 is a cross-sectional view showing an enlargement of a dielectric device 10 of this embodiment. As shown in FIG. 1, the dielectric device 10 includes a predetermined substrate 11, a base electrode 12, a dielectric layer 13 and an outer electrode 14.

### <<Substrate>>

The substrate 11 is of glass or ceramic material. The glass of the substrate 11 is preferably selected in view of the thermal expansion coefficient and thermal expansion curve of the dielectric layer 13 to be formed thereupon, and has characteristics which are close thereto. From the viewpoint of heat resistance, crystallized glass may also be used. The ceramics material, from the viewpoint of heat resistance, chemical stability and insulating properties, is preferably a ceramics material containing at least one moeity selected from among a group including aluminum oxide, magnesium oxide, mullite, aluminum nitride, silicon nitride and stabilized zirconium oxide. Stabilized zirconium oxide is particularly preferred as the material of the substrate 11 from the viewpoint that it has a large mechanical strength and superior toughness.

### <<Base Electrode>>

The base electrode 12 is formed on a substrate surface 11a, which is the upper surface in the diagram of the substrate 11. This base electrode 12 is a conductive film. The conductive film forming the base electrode 12 may be, for example, a metal material, cermet, carbon material or oxide material. These may be used alone, or in conjunction with each other.

Examples of a metal material which may be used are gold, silver, platinum, iridium, palladium, rhodium, molybdenum and tungsten. In addition to a single metal, this metal material may also be an alloy. Examples of alloys which are preferably used are silver-palladium, silver-platinum and platinum-palladium. An example of a cermet which is preferably used, is a cermet of platinum and a ceramic material.

Examples of a carbon material which may be used are graphite, diamond thin film, diamond-like carbon and carbon nanotube.

Examples of an oxide material which may be used are ruthenium oxide, iridium oxide, strontium ruthenate, La₁₋ₓSrₓCoO₃ (e.g., x=0.3 or 0.5), La₁₋ₓCaₓMnO₃, La₁₋ₓCaₓMn_{1-y}CO_{y}O₃ (e.g., x=0.2, y=0.05) and indium tin oxide (ITO).

The base electrode is provided so as to partially cover the substrate surface 11a. This base electrode 12 includes a base electrode edge part 12a and a base electrode body 12b.

The base electrode edge part 12a is formed as an outer rim of the base electrode 12, i.e., as an outer rim which defines the external shape of the base electrode 12. This base electrode edge part 12a may be formed also on the inner rim of a through hole or pinhole. The base electrode body 12b is the part of the base electrode 12 other than the base electrode edge part 12a.

A base electrode surface 12c is the surface in the upper portion of the diagram of the base electrode 12, which is formed at the interface between the base electrode 12 and the aforesaid dielectric layer 13. As shown in FIG. 1, the portion of this base electrode surface 12c corresponding to the base electrode edge part 12a is an inclined surface of gradual slope when viewed in side cross-section. In other words, as shown in FIG. 1, the surface of the base electrode edge part 12a opposite the dielectric layer 13 (base electrode surface 12c) is an inclined surface with a gradual slope when viewed in side cross-section.

Specifically, the surface of the base electrode edge part 12a connecting the portion of the substrate surface 11 a where the base electrode 12 is not formed with the top portion of the base electrode surface 12c (portion opposite the outer electrode 14), has an inclined portion with a gradual slope of 60° or less (more preferably, 30° or less). In other words, the base electrode edge part 12a is formed so that the angle between this portion of the substrate surface 11a and the base electrode surface 12c, is 90° or more (obtuse angle).

### <<Dielectric Layer>>

The aforesaid dielectric layer 13 is provided so as to cover the base electrode 12 on the substrate surface 11a. This dielectric layer 13 is of dielectric material.

The dielectric material which is the main component of the dielectric layer is preferably a material having a relatively high specific dielectric constant (e.g., 1000 or more). Examples of a dielectric material which may be used are barium titanate, lead zirconate, lead magnesium niobate, lead nickel niobate, lead zinc niobate, lead manganese niobate, lead magnesium tantalate, lead nickel tantalate, lead antimony stannate, lead titanate, lead magnesium tungstenate and lead cobalt niobate.

The dielectric layer 13 may be a ceramic material obtained by blending these dielectric materials as desired. The dielectric layer 13 may be a ceramic material containing 50 wt % or more of these dielectric materials as main component. Also, the dielectric layer 13 may further include an oxide or other compound of lanthanum, calcium, strontium, molybdenum, tungsten, barium, niobium, zinc, nickel or manganese (these may be blended together as required), which are added to the aforesaid dielectric material or ceramic.

The dielectric material of the dielectric layer 13 is preferably such that, in the annealing after depositing, the crystallinity of the dielectric material forming the dielectric layer 13 is easily recovered. For example, a mixture of lead zirconium titanate (PZT), lead zinc niobate (PZN) and lead titanium zirconate (PZT) is preferred.

The dielectric layer 13 is formed by annealing the deposited layer obtained by spraying a dielectric powder on the substrate 11 by the aerosol deposition method. In this dielectric layer 13, a triple point adjacent part 13a, which is a part near the triple point where the substrate 11, base electrode 12 and dielectric layer 13 come into contact, is situated opposite the aforesaid base electrode edge part 12a.

### <<Outer Electrode>>

The outer electrode 14 of a conductive film is formed on an upper surface 13b, which is a surface on the other side of the dielectric layer 13 opposite to the substrate 11. The outer electrode 14 is provided opposite to the base electrode 12 with the dielectric layer 13 sandwiched in the middle. The conductive film of this outer electrode 14 may be, for example, a metal material, cermet, carbon material or oxide material.

This dielectric device 10 is driven by applying a drive voltage having a predetermined waveform between the base electrode 12 and outer electrode 14 and applying a predetermined driving electric field to the dielectric layer 13.

### <<Method of Manufacturing Dielectric Device>>

Next, an aspect of the manufacturing method of the invention, which is the method of manufacturing the dielectric device 10 of this embodiment, will be described. In the following description of the manufacturing method, the reference numerals in FIG. 1 will be cited when referring to the parts of the dielectric device 10.

### <<First Aspect of Manufacturing Method>>

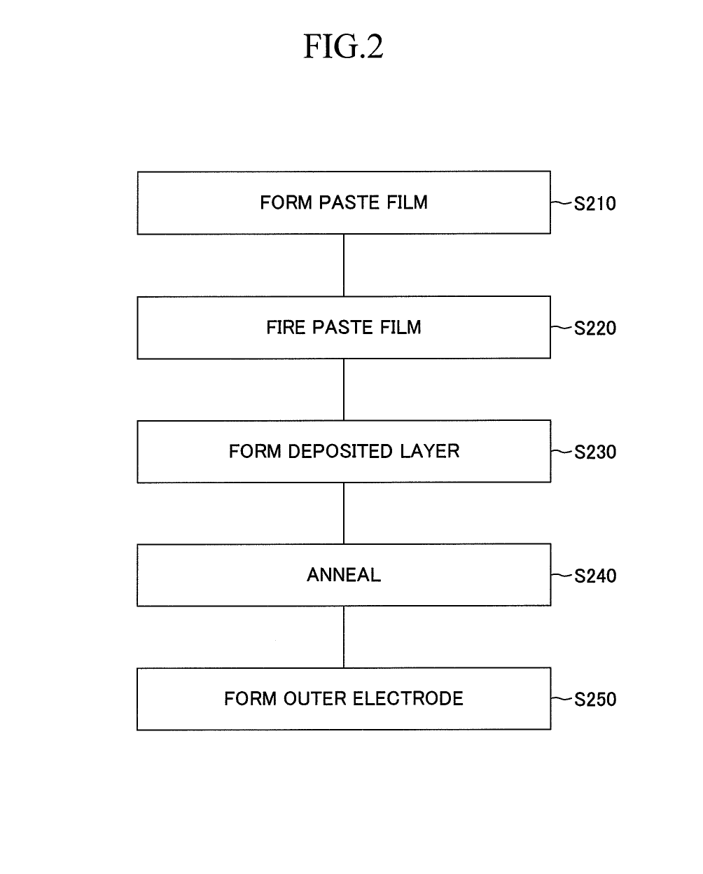

FIG. 2 is a flowchart showing an outline of a first aspect of the manufacturing method of the invention. As shown in FIG. 2, this manufacturing method includes a paste film-forming step S210 (S is an abbreviation for step, hereafter idem), paste film firing step S220, deposited layer forming step S230 and heat annealing step S240. The paste film-forming step S210 and paste film firing step S220 constitute the base electrode-forming step of the invention.

First, in the paste film-forming step S210, a paste film which will become the base electrode 12 is formed on the substrate surface 11a. This paste film is obtained by forming a film of a paste, which is a mixture of a base material and an additive, on the substrate surface 11a. The base material is preferably a metal paste. The additive may be an oxide or another inorganic component. This inorganic component is a component which glassifies under heating in the subsequent paste film firing step. For example, this inorganic component may be fine glass particle or clay.

In this paste film-forming step S210, various thick film-forming methods such as spin coating, screen printing, spraying, coating, dipping and painting may conveniently be used.

Next, in the paste film firing step S220, the paste film is heat-treated. Due to this heat-treating, the additive migrates to the edge of the paste film. The base electrode edge part 12a is formed by the additive which has migrated to the edge of the paste film. Also, the base electrode body 12b is formed by the base material from which the solvent has vaporized to a convenient extent due to annealing.

Next, in the deposited layer forming step S230, the deposited layer containing the aforesaid dielectric material is formed on the substrate surface 11a so as to cover the base electrode 12. This deposited layer forming step S230 is a step for forming a deposited layer of dielectric material by spraying powdered dielectric material on the substrate 11. In this deposited layer forming step S230, the “aerosol deposition method” may conveniently be used. In this aerosol deposition method, the deposited layer is obtained by dispersing the dielectric material in a powdered state in a gas using vibration or the like so as to form a smoke or aerosol, transporting this aerosol to a deposition chamber at a predetermined reduced pressure, and spraying it on the substrate 11 via a nozzle.

According to this aerosol deposition method, the film of the deposited layer is formed while crushing the sprayed dielectric powder. Therefore, the surface state (surface roughness, etc.) of the deposited layer can be stably controlled. Also, a finely structured deposited layer wherein the crystalline structure of the dielectric powder is maintained and which has few voids, can be formed. Further, the deposited layer is strongly fixed to the substrate surface 11a.

Next, in the annealing step S240, annealing is performed on the deposited layer. By restoring the crystallinity of the deposited layer by annealing, the dielectric layer 13 having superior dielectric film characteristics such as piezoelectric properties, is formed.

Next, in an outer electrode-forming step S250, the outer electrode 14 is formed on the dielectric layer 13. This outer electrode-forming step S250 is performed in the same way as the aforesaid paste film-forming step S210 and paste film firing step S220.

### <<Second Aspect of Manufacturing Method>>

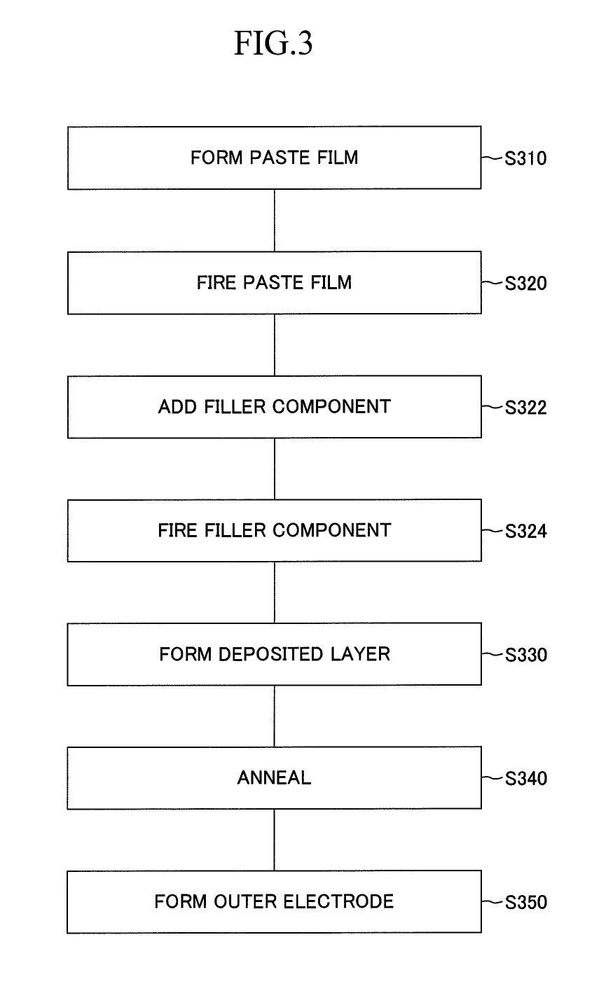

FIG. 3 is a flowchart showing an outline of a second aspect of the manufacturing method of the invention. As shown in FIG. 3, this manufacturing method includes a paste film-forming step S310, a paste film firing step S320, a filler component addition step S322, a filler component firing step S324, a deposited layer forming step S330 and an annealing step S340. The paste film-forming step S310, paste film firing step S320, filler component addition step S322 and filler component firing step S324 constitute the base electrode-forming step of the invention.

First, in the paste film-forming step S310, a film of a metal paste which will become the base electrode body 12b is formed on the substrate surface 11a. This metal paste corresponds to the base material in the manufacturing method of the first aspect described above. The film of metal paste is formed by an identical method to that of the aforesaid paste film-forming step S210.

Next, in the paste film firing step S320, the aforesaid paste film is heat-treated. In this way, the base electrode body 12b is formed.

Next, in the filler component addition step S322, the base electrode body 12b is impregnated with a solution containing a component corresponding to the aforesaid additive. In the filler component firing step S324, the base electrode main body 12b impregnated with the aforesaid solution is heat-treated. Due to this heat-treating, the aforesaid component migrates to the edge of the base electrode body 12b. The base electrode edge part 12a is formed by this component which has migrated to the edge of the base electrode body 12b.

Next, in the deposited layer forming step S330, the deposited layer containing the aforesaid dielectric material is formed on the substrate surface 11a so as the cover the base electrode 12. This deposited layer forming step S330 is an identical step to the aforesaid deposited layer forming step S230.

Next, in the annealing step S340 which is identical to the manufacturing method of the first aspect described above, annealing is performed on the deposited layer. The fine deposited layer 13 having superior characteristics due to relaxation of internal stresses in the deposited layer is formed by this annealing. Further, in an outer electrode-forming step S350 identical to that of the manufacturing method of the first aspect, the outer electrode 14 is formed on the dielectric layer 13.

### <<Example of Forming Dielectric Layer by Aerosol Deposition Method>>

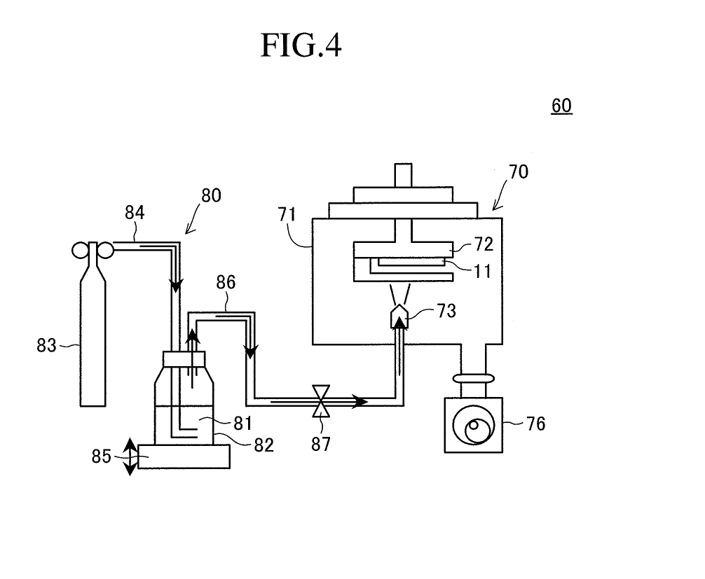

FIG. 4 is a diagram showing the schematic construction of an aerosol deposition equipment 60 used in the deposited layer forming step S230 of FIG. 2, and the deposited layer forming step S330 of FIG. 3. This aerosol deposition equipment 60 includes a deposition chamber 70 and an aerosol supply part 80.

The deposition chamber 70 includes a vacuum container 71, an XYZ θ stage 72, a nozzle 73 and vacuum pump 74. The vacuum container 71 is formed such that a predetermined degree of vacuum is maintained therein. The XYZ θ stage 72 is capable of displacing the substrate 11 in any desired direction while the substrate 11 is held inside the vacuum container 71. The nozzle 73 is fixed inside the vacuum container 71. This nozzle 73 can spray an aerosol on the substrate 11 held by the XYZ θ stage 72. The vacuum pump 74 discharges air from the vacuum container 71 to set the vacuum container 71 at the predetermined degree of vacuum described above.

The aerosol supply part 80 supplies a starting material powder 81 which is sprayed on the substrate 11 by the nozzle 73, to the nozzle 73. This starting material powder 81 is a powder of a dielectric material.

This aerosol supply part 80 includes an aerosol chamber 82, a compressed gas supply source 83, a compressed gas supply tube 84, a vibrating stirrer 85, an aerosol supply tube 86 and a control valve 87.

The aerosol chamber 82 is a container which can store the starting material powder 81. The compressed gas supply source 83 stores a carrier gas for the purpose of generating an aerosol by mixing with the starting material powder 81 in the aerosol chamber 82. Examples of a carrier gas which may be used are compressed air, helium, argon or another rare gas, or an inert gas such as nitrogen. The compressed gas supply tube 84 supplies the carrier gas from the compressed gas supply source 83 to the aerosol chamber 82. The vibrating stirrer 85 gives a vibration to the aerosol chamber 82 so as to generate the aerosol by mixing the starting material powder 81 with the carrier gas in the aerosol chamber 82. The aerosol supply tube 86 supplies the aerosol generated in the aerosol chamber 82 to the nozzle 73. The control valve 87 controls the aerosol amount supplied from the nozzle 73 to the substrate 11 by adjusting the flowrate of aerosol in the aerosol supply tube 86.

The aerosol deposition equipment 60 having the aforesaid construction, operates as follows.

The starting material powder 81 is vigorously mixed with the carrier gas due to the vibration from the vibrating stirrer 85 in the aerosol chamber 82. Due to this, aerosol is generated in the aerosol chamber 82. This aerosol exhibits fluid behavior, so when the control valve 87 is open, the aerosol flows toward the vacuum container 71 due to the pressure difference between the aerosol chamber 82 and the vacuum container 71, and is sprayed on the substrate 11 at high speed via the nozzle 73. Hence, by opening the control valve 87, and spraying the aerosol containing the starting material powder 81 on the substrate 11, the deposited layer which will become the dielectric layer 13 is formed on the substrate 11 (or more precisely, the base electrode 12 in FIG. 1).

### EXAMPLES

Next, some examples of the dielectric device of the invention and its manufacturing method will be described in comparison with comparative examples. In the description of the following examples, the reference numerals in the aforesaid FIG. 1 to FIG. 4 will be cited when referring to parts of the dielectric device 10 and the steps of the various aspects.

In the following examples, the substrate 11 is a soda glass plate having a thickness of 1.1 mm. Also, the base electrode 12 is formed in a rectangular shape measuring 10 mm×20 mm. The starting material powder 81 forming the dielectric layer 13 is a commercial powder of PZT. This dielectric layer 13 is formed having a thickness of 6 to 8 μm.

### Example 1

The manufacturing method of Example 1 is the manufacturing method of the first aspect shown in FIG. 2. In this first example, in the paste film-forming step S210, a film having a thickness of 4 μm of a base electrode-forming paste including a mixture of commercial silver paste and commercial glass paste is formed on the substrate surface 11a. The glass component of this glass paste is lead borosilicate glass. This base electrode-forming paste is prepared so that the ratio of glass to silver is 20% in terms of volume.

Next, in the paste film firing step S220, the aforesaid paste film is fired at 600° C. in a belt furnace.

A deposited layer of PZT formed by the aerosol deposition method, in the annealing step S240, is then annealed at 600 ° C. for 0.5 hours in a batch furnace.

The triple point adjacent part 13a in the dielectric layer 13 formed by the manufacturing method of this first example has a very fine structure as in the case of the other parts. Therefore, cracks do not occur in this part. The structure and the presence or absence of cracks in this triple point adjacent part 13a can be verified by observing a cross-section with a scanning electron microscope.

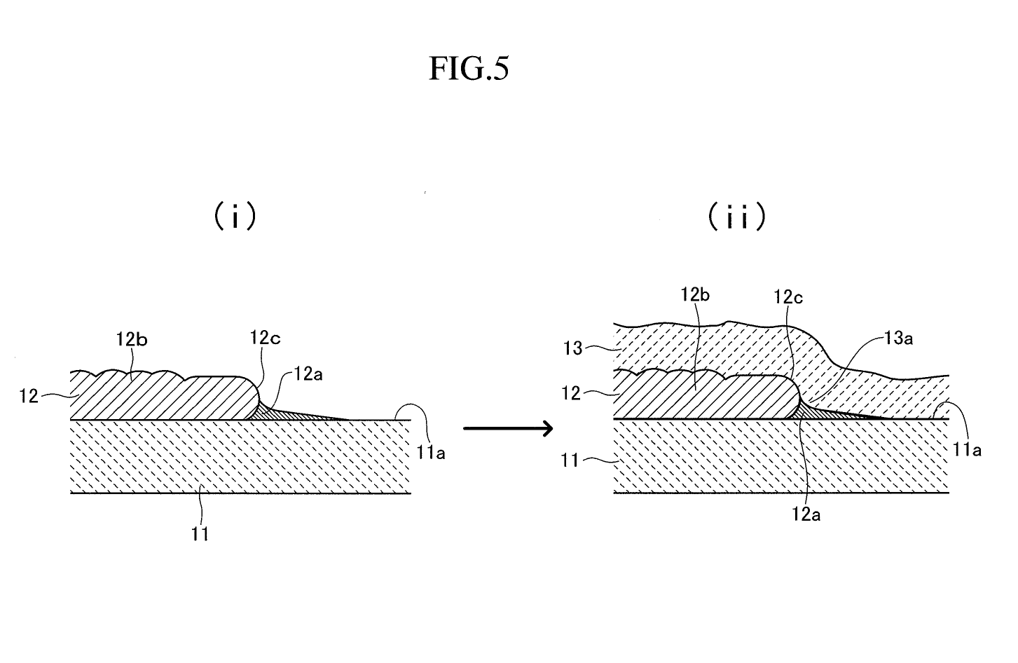

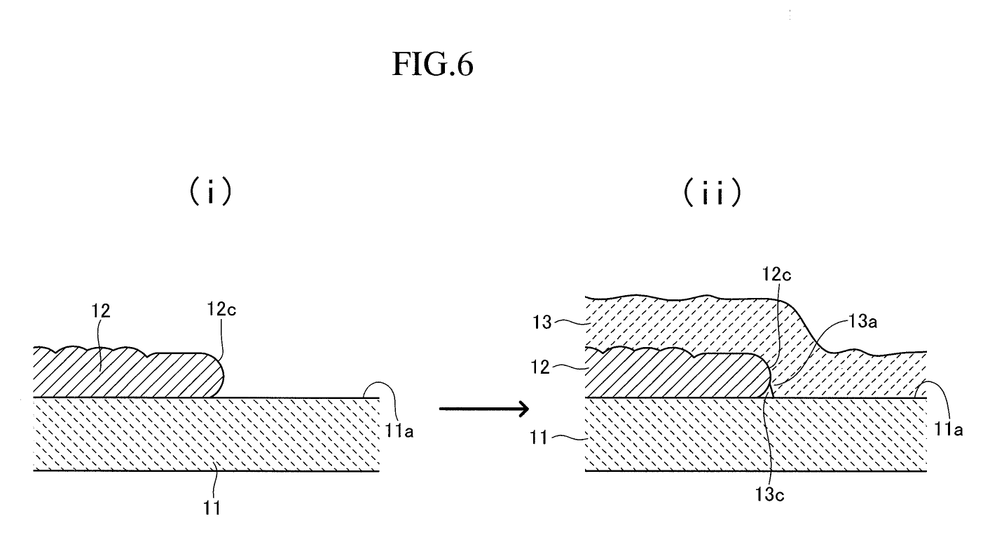

FIG. 5 is a side cross-sectional view schematically showing the processes of forming the base electrode 12 and dielectric layer 13 in the manufacturing method of Example 1. FIG. 6 is a side cross-sectional view schematically showing the processes of forming the base electrode 12 and dielectric layer 13 in a comparative manufacturing method.

As shown in (i) in FIG. 5, in the paste film firing step S220, the base electrode edge part 12a, which is a glass component, is formed on the edge of the base electrode body 12b which is of silver. This base electrode edge part 12a is formed when the glass component, glassified by heating in the paste film firing step S220, migrates to the edge part of the base electrode body 12b. When this base electrode edge part 12a is formed, the aforesaid glass component exhibits good wettability with respect to the substrate 11. Therefore, the portion of the base electrode surface 12c corresponding to the base electrode edge part 12a is formed with a gradual inclined surface.

When the dielectric powder is sprayed by the aerosol deposition method on the substrate surface 11a whereupon the base electrode 12 having this shape is formed, the portion of the base electrode surface 12c corresponding to the base electrode edge part 12a is straightly face the spray direction of the dielectric powder. Hence, regarding the spray direction of the dielectric powder, a “shadow” or a blind spot is not produced on the edge part of the base electrode 12. Therefore, as shown by (ii) in FIG. 5, the dielectric powder can be sprayed in sufficient amount even on the edge part of the base electrode 12. Due to this, the aforesaid triple point adjacent part 13a in the dielectric layer 13 has a fine structure as in the case of the other parts.

On the other hand, as shown by (i) in FIG. 6, if an acute angle depression is formed on the edge part of the base electrode 12, this depression becomes a “shadow” in the spray direction of the dielectric powder. Therefore, as shown in (ii) of FIG. 6, an incomplete deposition part 13c having a coarse structure is formed at the position corresponding to this depression. If this incomplete deposition part 13c is formed, in the subsequent annealing step (S240 in FIG. 2), stress due to differences in the thermal expansion coefficients of the substrate 11, base electrode 12 and dielectric layer 13 concentrates in this incomplete deposition part 13c. Due to the stress concentration, cracks can occur in the incomplete deposition part 13c.

### Example 2

The manufacturing method of Example 2 is essentially identical to that of Example 1 except that, instead of the glass paste of Example 1, a paste of colloidal silica is used. In the base electrode-forming paste of this second example, the ratio of silica to silver is adjusted to be 20% in terms of volume.

As in the case of Example 1, the triple point adjacent part 13a in the dielectric layer 13 formed by the manufacturing method of Example 2 also has a very fine structure with no cracks.

### Example 3

The manufacturing method of Example 3 is essentially identical to that of Example 2 except that, instead of the silver paste of Example 1, a commercial silver resinate is used. In the base electrode-forming paste of Example 3, the ratio of silica to silver is adjusted to be 20% in terms of volume. The paste film in Example 3 is formed with a thickness of 1 μm.

As in the case of Examples 1 and 2, the triple point adjacent part 13a in the dielectric layer 13 formed by the manufacturing method of Example 3 also has a very fine structure with no cracks.

### Example 4

The manufacturing method of Example 4 is the manufacturing method of the second aspect shown in FIG. 3. In Example 4, in the paste film-forming step S310, a film of commercial silver paste having a thickness of 4 μm is formed on the substrate surface 11a.

Next, in the paste film firing step S320, the aforesaid silver paste film is sintered at 600 ° C. by a belt furnace. The base electrode body 12b of silver is thereby formed.

Next, in the filler component additive step S322, the base electrode body 12b of silver is impregnated with a paste of colloidal silica.

In the filler component firing step S324, the base electrode body 12b impregnated with colloidal paste is then annealed. Due to this, as shown in FIG. 5, the base electrode edge part 12a of silica is formed.

Next, as in the aforesaid examples, in the deposited layer forming step S330, a deposited layer of PZT is formed, and in the annealing step S340, this deposited layer is annealed at 600 ° C. for about 0.5 hours in a batch furnace.

As in the aforesaid examples, the triple point adjacent part 13a in the dielectric layer 13 formed by the manufacturing method of Example 4 also has a very fine structure with no cracks.

### Comparative Example

On the other hand, as shown by (i) in FIG. 6, after firing the film of commercial silver paste having a thickness of 4 μm, or the film of commercial silver resinate having a thickness of 1 μm, when the dielectric layer 13 is formed by spraying dielectric powder and annealing, as shown by (ii) in FIG. 6, the incomplete deposition part 13c is formed. In this incomplete deposition part 13c, cracks may occur.

### Effect of the Aspects and Examples

As described above, in the dielectric device 10 of this embodiment, the surface of the base electrode edge part 12a which connects the portion of the substrate surface 11 a where the base electrode 12 is not formed, with the top portion of the base electrode surface 12c, has an inclined portion with a gradual slope of 60° or less (more preferably, 30° or less). Specifically, the base electrode 12 is formed so that the angle between this portion of the substrate surface 11a and the portion of the base electrode surface 12c corresponding to the base electrode edge part 12a, is 90° or more.

According to this construction, the occurrence of stress concentration in the dielectric layer 13 in the vicinity of the base electrode edge part 12a, which is due to differences in the thermal expansion coefficients of the dielectric materials constituting the substrate 11, base electrode 12 and dielectric layer 13 during the annealing step to form the dielectric layer 13, can be effectively suppressed. In particular, when the dielectric layer 13 is formed by the aerosol deposition method, parts with a coarse structure (incomplete deposition part 13c in FIG. 6) in the vicinity of the base electrode edge part 12a, can be effectively suppressed.

Therefore, according to the dielectric device 10 of this aspect, the occurrence of cracks in the dielectric layer 13 when a heat-treating such as a firing or an annealing is performed to form the dielectric layer 13, can be effectively suppressed.

Also, according to the manufacturing methods of the aforesaid aspects and examples, the dielectric device 10 including the dielectric layer 13 having superior characteristics formed by the aerosol deposition method, can be manufactured in good yield.

### <<Exemplification of Some Modifications>>

In the aforesaid aspects and examples, as described above, the typical aspects and examples representative of the invention considered to be optimum by the Inventor at the time of the present application, are merely examples. Therefore, the invention is not to be construed as being limited in anyway by the aforesaid aspects and examples. Therefore, it will be understood that various modifications of these aspects and examples may be made subject to the limitation that the essential parts of the invention are not modified.

Hereafter, some examples of specific modifications will be described. In the description of the following modifications, members having an identical construction and function to those described in the aspects and examples are assigned identical reference numerals to those of the aforesaid aspects and examples. In the description of these members, the description of the aforesaid aspects and examples will apply provided that there are no technical contradictions.

It will of course be understood that the following examples of modifications are not to be construed as being limited in any way. Also, plural modifications may be suitably combined together to the extent that there are no technical contradictions.

The invention (in particular, the typical effects and functions of the component elements constituting the means for resolving the problems of the invention) is not to be understood as being limited by the aforesaid aspects, examples and modifications.

(i) The object of the present invention is not limited to the aforesaid electron emitter or piezoelectric actuator. The invention may also be applied to, for example, a ceramics filter such as a SAW filter, a piezoelectric buzzer, a piezoelectric vibrating gyro, a piezoelectric microphone, various piezoelectric sensors and a Rosen piezoelectric transformer.

(ii) The material of the substrate 11, in addition to glass and ceramics, may also be metal.

(iii) The base electrode edge part 12a may be formed in one piece and of the same material as that of the base electrode body 12b. Specifically, for example, if the base electrode 12 is formed of a lower melting point metal (zinc or gold), the base electrode edge part 12a including this lower melting point metal may be formed by a simple step by annealing the base electrode 12.

In this case, various surface treatments such as plasma treatment may be given to the substrate surface 11a so that the substrate surface 11a exhibits good wetting properties with respect to the aforesaid lower melting point metal.

(iv) In the base electrode-forming paste for forming the base electrode 12, the proportion of the additive relative to the material (metal, etc.) forming the base electrode body 12b may be 0.1 to 20% in terms of volume.

(v) The shape of the base electrode 12 is not particularly limited. For example, the base electrode 12 may be formed in the shape of a comb or another pattern. Alternatively, the base electrode 12 may be formed as a common electrode opposite the plural outer electrodes 14.

(vi) A metal may be dispersed in the dielectric layer 13 to the extent that it does not impair dielectric thin film properties such as the piezoelectric effect, piezoelectric inverse effect and polarization inversion. Examples of a metal which may be used are silver, copper, gold and platinum. In particular, gold and silver are preferred as they are low melting point and difficult to oxidize.

According to this construction, by dispersing this metal in a matrix of dielectric material, the dielectric constant of the dielectric layer 13 increases. In this case, the dielectric layer 13 is preferably formed so that the metal content is 10% or less in terms of volume of the whole of the dielectric layer 13.

Herein, the mixing of the metal with the dielectric layer 13 is preferably performed by aerosol deposition. Specifically, by spraying an aerosol including a mixture of the dielectric material powder and metal particles as the starting material powder 81 onto the substrate 11, the metal particles having ductility act as a binder. Therefore, deposition properties on the substrate 11 are improved.

Further, the dielectric layer 13 may be formed to have a distribution such that the metal content in the thickness direction is not uniform. Specifically, the dielectric layer 13 may be formed so that the metal content is different near the base electrode and near the outer electrode.

(vii) In addition, elements having typical effects and functions among the elements constituting the means for resolving the problems of the invention, apart from the specific structures disclosed in the aforesaid aspects and examples, may have any structure capable of implementing the effects and functions.

What is claimed is:

1. A dielectric device comprising:
a substrate;
a base electrode including a conductive film provided on the surface of the substrate; and
a dielectric layer provided so as to cover the base electrode,
wherein a base electrode is formed so that a surface of an edge part of the base electrode is an inclined surface having an inclination angle of 90° or less.

2. The dielectric device according to claim 1,
wherein the base electrode comprises:
the edge part formed from a material having a non-metal as its main component, and
an electrode body which is a part other than the edge part, and which is formed from a material having a metal as its main component.

3. The dielectric device according to claim 2,
wherein the edge part is formed from an oxide, or an inorganic component which is glassified when the base electrode is formed by annealing of a paste film formed on the surface of the substrate.

4. The dielectric device according to claim 3, further comprising an outer electrode provided on the dielectric layer.

5. The dielectric device according to claim 4,
wherein the dielectric layer is formed by annealing of a deposited layer obtained by spraying a powdered dielectric on the substrate.

6. A method of manufacturing a dielectric device, comprising:
a base electrode-forming step of forming a base electrode on a surface of a predetermined substrate;
a deposited layer forming step of forming a deposited layer of a dielectric so as to cover the base electrode on the surface of the substrate; and
a deposited layer annealing step of obtaining a dielectric layer by annealing the deposited layer,
wherein the base electrode-forming step is a step wherein the base electrode is formed such that a surface of an edge part of the base electrode is an inclined surface having an inclination angle of 90° or less.

7. The method of forming a dielectric device according to claim 6,
wherein the base electrode-forming step is a step of forming:
the edge part formed from a material having a non-metal as its main component; and
an electrode body which is a part other than the edge part, and which is formed from a material having a metal as its main component.

8. The method of manufacturing a dielectric device according to claim 7,
wherein the base electrode-forming step comprises:
a paste film-forming step of forming a film of a paste which is a mixture of a base material and an additive which is an inorganic component glassified by heating or an oxide, on the surface of the substrate; and
a paste film heat-treatment step of heat-treating the film of the paste and migrating the additive so as to form the electrode body including the base material and the edge part including the additive.

9. The method of forming a dielectric device according to claim 8, further comprising:
an outer electrode-forming step of forming an outer electrode on the dielectric layer.

10. The method of forming a dielectric device according to claim 9,
wherein the deposited layer forming step is a step of obtaining the deposited layer by spraying a powdered dielectric on the surface of the substrate.
